(19) United States
(12) Patent Application Publication
(10) Pub. No.: US 2017/0212389 A1
(43) Pub. Date: Jul. 27, 2017

(54) LIQUID CRYSTAL DISPLAY DEVICE AND METHOD FOR PRODUCING THE SAME

(71) Applicant: Sharp Kabushiki Kaisha, Sakai City, Osaka (JP)

(72) Inventors: Hiroaki ASAGI, Sakai City (JP); Isamu MIYAKE, Sakai City (JP)

(21) Appl. No.: 15/329,278

(22) PCT Filed: Jul. 24, 2015
(86) PCT No.: PCT/JP2015/071055

§ 371 Date: Jan. 26, 2017

(30) Foreign Application Priority Data
Jul. 31, 2014 (JP) 2014-157114

(51) Int. Cl. G02F 1/1337; G02F 1/1343; G02F 1/1335

(52) U.S. Cl. CPC G02F 1/133711; G02F 1/133528; G02F 1/134363; G02F 1/13439; G02F 1/133788; G02F 2001/133749; G02F 2001/134372; G02F 2201/123

(57) ABSTRACT

The present invention provides a liquid crystal display device that can maintain favorable contrast characteristics for a long period of time using a photo-alignment film. The liquid crystal display device includes in the following order from a back surface side: a backlight that emits light including visible light; a linear polarizer; a first substrate; an alignment film; a liquid crystal layer that contains liquid crystal molecules; and a second substrate, the alignment film containing a material with an azobenzene structure that exhibits anisotropic absorption of visible light and isomerizes upon absorption of visible light, the linear polarizer having a polarized light transmission axis that intersects a direction in which the alignment film has larger absorption anisotropy.

### TECHNICAL FIELD

The present invention relates to liquid crystal display devices and methods for producing the same. The present invention more specifically relates to a liquid crystal display device including an alignment film designed to control the alignment of liquid crystal molecules, and a method for producing the same.

### BACKGROUND ART

Liquid crystal display devices utilize a liquid crystal composition for display. A typical display method thereof is applying voltage to the liquid crystal composition sealed between paired substrates to change the alignment state of the liquid crystal molecules in the liquid crystal composition according to the applied voltage, thereby controlling the amount of light transmission. These liquid crystal display devices having characteristics such as thin profile, light weight, and low power consumption have been used in a broad range of fields.

The alignment of liquid crystal molecules with no voltage applied is typically controlled by alignment films having been subjected to an alignment treatment. Although rubbing has been a widely used alignment treatment method, photo-alignment methods allowing non-contact alignment treatment have now been studied and developed. Alignment films subjected to photo-alignment treatment have been found to cause alignment disorder under external light such as sunlight (for example, see Patent Literature 1).

The invention disclosed in Patent Literature 1 aims to prevent alignment disorder due to ultraviolet light included in sunlight incident from the viewing side. This invention attempts to prevent alignment disorder due to external light by setting the polarized light transmission axis direction of the polarizer on the viewing side and the polarization direction of the polarized light radiated in photo-alignment treatment to the same direction.

### CITATION LIST

Patent Literature
Patent Literature 1: WO 2013/024750

### SUMMARY OF INVENTION

### Technical Problem

The inventors of the present invention have focused on a photo-alignment film containing azobenzene as a photo-functional group, which is expected to be able to exhibit high-quality display performance and be useful in achieving a higher contrast ratio of IPS-mode liquid crystal panels and FFS-mode liquid crystal panels. This photo-alignment film is made of a photoisomerizable material which becomes anisotropic by repeatedly undergoing a trans-cis reaction by polarized ultraviolet light irradiation and allowing the trans-azobenzene structures aligned in the direction perpendicular to the polarized light irradiation direction to be dominant. However, in the course of the study on such a photo-alignment film containing azobenzene as the photo-functional group, the inventors have found that the contrast characteristics tend to deteriorate with time during use of the liquid crystal display device.

The present invention has been made in view of the above current state of the art, and aims to provide a liquid crystal display device capable of maintaining favorable contrast characteristics for a long period of time using a photo-alignment film, and a method for producing the same.

### Solution to Problem

The inventors have studied how the use of a photo-alignment film containing azobenzene as a photo-functional group deteriorates the contrast characteristics with time. As a result, the inventors have found that cis-azobenzene, which responses to blue visible light having a wavelength of about 400 to 500 nm, remains in the alignment film for which the alignment treatment has been completed, and cis-azobenzene is the cause of the contrast characteristics deterioration. The inventors have then found that, since cis-azobenzene has absorption anisotropy, the reaction of cis-azobenzene can be prevented by employing a configuration in which the absorption axes of the cis-azobenzene molecules in the alignment film intersect (preferably at a right angle) the polarization direction of light incident through a polarizer from the backlight. Thereby, the inventors have arrived at a solution of the above problem, completing the present invention.

One aspect of the present invention may be a liquid crystal display device including in the following order from a back surface side: a backlight that emits light including visible light; a linear polarizer; a first substrate; an alignment film; a liquid crystal layer that contains liquid crystal molecules; and a second substrate. The alignment film contains a material with an azobenzene structure that exhibits anisotropic absorption of visible light and isomerizes upon absorption of visible light. The linear polarizer has a polarized light transmission axis that intersects a direction in which the alignment film has larger absorption anisotropy.

Patent Literature 1 suggests a configuration of disposing two polarizing plates in crossed Nicols, with an arrangement of the liquid crystal alignment direction and the polarizing plates being different by 90° from the arrangement in the above aspect.

Another aspect of the present invention may be a method for producing the above liquid crystal display device, including an alignment treatment for the alignment film using linearly polarized ultraviolet light with a degree of polarization of 30:1 or higher.

### Advantageous Effects of Invention

The liquid crystal display device of the present invention having the above configuration can prevent cis-azobenzene contained in the alignment film after the photo-alignment treatment from absorbing backlight illumination. The liquid crystal display device therefore can prevent the isomerization reaction generating trans-azobenzene that aligns the molecules in a direction different from the alignment direction provided by the photo-alignment treatment. Thereby, the liquid crystal display device can maintain favorable alignment control using the alignment film even when the backlight is turned on for a long period of time. Accordingly, the present invention can provide a liquid crystal display device that prevents an increase in light leakage in black display and has favorable contrast characteristics for a long period of time.

### BRIEF DESCRIPTION OF DRAWINGS

FIG. 1 is an exploded perspective view schematically illustrating the configuration of a liquid crystal display device of Embodiment 1.

FIG. 2 is a view for describing the relation between an alignment film and liquid crystal molecules in a horizontal alignment mode.

FIG. 3 is a graph showing the order parameter of a post-baked photo-alignment film used in Example 1.

FIG. 4 is a graph showing the luminescence spectrum of a white LED backlight.

FIG. 5 is a graph showing initial contrast measurement results of liquid crystal panels of Examples 1 to 3.

FIG. 6 is a schematic cross-sectional view of the configuration in the vicinity of a pixel electrode on a TFT substrate used in Examples 6 and 7.

FIG. 7 is an exploded perspective view schematically illustrating the configuration of a liquid crystal display device of Example 8.

FIG. 8 is a view for describing photo-alignment treatment in Example 8.

FIG. 9 is a view for describing the relation between photo-functional groups and liquid crystal molecules in a vertical alignment mode.

FIG. 10 is a view for describing the relation between the polarization provided by photo-alignment treatment and the direction of the absorption axis of a cis-azobenzene structure in a vertical alignment mode.

FIG. 11 is an exploded perspective view schematically illustrating the configuration of a liquid crystal display device of Comparative Example 1.

### DESCRIPTION OF EMBODIMENTS

Hereinafter, embodiments of the present invention are described. The following embodiments, however, are not intended to limit the scope of the present invention. The present invention may appropriately be modified within the scope of the configuration of the present invention.

The same components or components having the same or similar function in the drawings are commonly provided with the same reference sign, and description of such components is not repeated.

### Embodiment 1

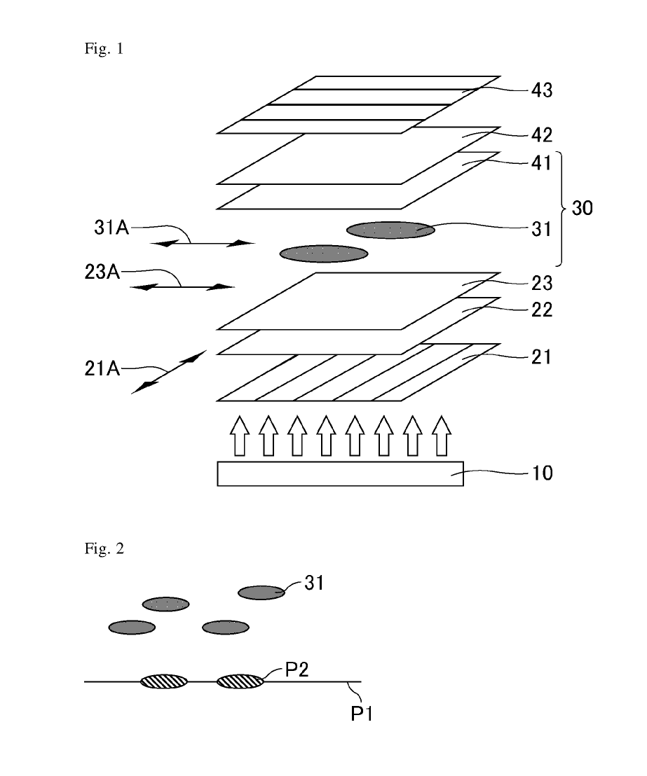

FIG. 1 is an exploded perspective view schematically illustrating the configuration of a liquid crystal display device of Embodiment 1.

The liquid crystal display device of Embodiment 1 includes in the following order from a back surface side: a backlight 10 that emits light including visible light; a linear polarizer 21; a first substrate 22; an alignment film 23; a liquid crystal layer 30 that contains liquid crystal molecules 31; and a second substrate 42. The alignment film 23 contains a material with an azobenzene structure that exhibits anisotropic absorption of visible light and isomerizes upon absorption of visible light. The linear polarizer 21 has a polarized light transmission axis that intersects a direction in which the alignment film 23 has larger absorption anisotropy.

Hereinafter, the liquid crystal display device of the present embodiment is described in detail.

As illustrated in FIG. 1, the liquid crystal display device of the present embodiment includes the backlight 10 on the back surface side of the liquid crystal panel. A liquid crystal display device having such a configuration is usually called a transmissive liquid crystal display device. The backlight 10 may be any backlight that emits light including visible light, and may be one that emits light with only visible light or emits light including both visible light and ultraviolet light. In order to enable the liquid crystal display device to provide color display, a backlight emitting white light is suitable for the backlight 10. The types of the backlight 10 include, for example, light emitting diodes (LED) and cold cathode fluorescent lamps (CCFL). The “visible light” as used herein refers to light (electromagnetic waves) having a wavelength of 380 nm to shorter than 800 nm.

The linear polarizer (polarizing plate) 21 is disposed on the viewing side of the backlight 10. The light emitted from the backlight 10 travels in the direction indicated by the arrows in FIG. 1 to be incident on the linear polarizer 21. The light incident on the linear polarizer 21 is converted into linearly polarized light that oscillates along the polarized light transmission axis of the linear polarizer 21. Typical examples of the linear polarizer 21 include those obtained by aligning a dichroic anisotropic material such as an iodine complex adsorbed on a polyvinyl alcohol (PVA) film. Generally, each surface of the PVA film is laminated with a protective film such as a triacetyl cellulose film before the film is put into practical use. An optical film such as a retardation film may be disposed between the linear polarizer 21 and the first substrate 22.

The first substrate 22, the liquid crystal layer 30, and the second substrate 42 are disposed in the given order on the viewing side of the linear polarizer 21. The first substrate 22 and the second substrate 42 are attached to each other with a sealant (not illustrated) provided to surround the liquid crystal layer 30, so that the first substrate 22, the second substrate 42, and the sealant hold the liquid crystal layer 30 in a given region.

The first substrate 22 and the second substrate 42 may be, for example, an active matrix substrate (thin-film transistor (TFT) substrate) and a color filter (CF) substrate in combination. The active matrix substrate can be one usually used in the field of liquid crystal display devices. An active matrix substrate in a plan view may have a configuration including, on a transparent substrate, gate signal lines parallel to each other; source signal lines that extend perpendicularly to the gate signal lines and are parallel to each other; thin-film transistors disposed at the respective corresponding intersections of the gate signal lines and the source signal lines; and pixel electrodes disposed in the respective corresponding regions defined by the gate signal lines and the source signal lines in a matrix form, for example.

The color filter substrate can be one usually used in the field of liquid crystal display devices. A color filter substrate may have a configuration including, on a transparent substrate, a black matrix formed in a grid pattern; and color filters formed in the respective grids, i.e., in the respective pixels, for example.

Both the color filters and the active matrix elements may be provided to one of the first substrate 22 and the second substrate 42.

Examples of the transparent substrate used in each of the active matrix substrate and the color filter substrate include those made of glass such as float glass or soda-lime glass; and those made of a plastic such as polyethylene terephthalate, polybutylene terephthalate, polyether sulfone, polycarbonate, or alicyclic polyolefin.

The liquid crystal layer 30 contains the liquid crystal molecules 31. The liquid crystal molecules 31 are preferably those having negative anisotropy of dielectric constant (negative liquid crystal). The liquid crystal display device may be in any display mode, such as an in-plane switching (IPS) mode, a fringe field switching (FFS) mode, or a twisted nematic (TN) mode. In particular, the IPS mode and the FFS mode are suitable for use.

The sealant can be, for example, an epoxy resin containing inorganic or organic filler and a curing agent.

The alignment film 23 is disposed between the first substrate 22 and the liquid crystal layer 30. As illustrated in FIG. 1, an alignment film 41 may be disposed between the liquid crystal layer 30 and the second substrate 42. The alignment films 23 and 41 each have a function of controlling the alignment of the liquid crystal molecules 31 in the liquid crystal layer 30. With voltage lower than the threshold voltage applied to the liquid crystal layer 30 (including the case of no voltage application), the liquid crystal display device mainly utilizes the alignment films 23 and 41 to control the alignment of the liquid crystal molecules 31 in the liquid crystal layer 30. The angle of the major axis of each liquid crystal molecule 31 from the surface of the first substrate 22 or the second substrate 42 in such a controlled state is called a “pre-tilt angle”. The “pre-tilt angle” as used herein refers to the angle of tilt of liquid crystal molecules from the direction parallel to the substrate surface, with the angle direction parallel to the substrate surface being 0° and the angle direction which is the same as the normal direction of the substrate surface being 90°.

The alignment films 23 and 41 may provide any pre-tilt angle to the liquid crystal molecules 31. The alignment films 23 and 41 may be horizontal alignment films or vertical alignment films, but are preferably horizontal alignment films. In the case that the alignment films 23 and 41 are horizontal alignment films, the pre-tilt angle is preferably substantially 0° (e.g., smaller than 10°), more preferably 0° for achievement of the effect of maintaining favorable contrast characteristics for a long period of time. In the case that the display mode is the IPS mode or FFS mode, the pre-tilt angle is also preferably 0° from the viewpoint of viewing angle characteristics, whereas in the case that the display mode is the TN mode, the pre-tilt angle is preferably set to about 2°, for example, due to the restrictions in the mode.

The alignment film 23 contains a material with an azobenzene structure. Examples of the material with an azobenzene structure include those disclosed in JP 2013-242526 A, namely the compounds represented by the formulas (VII-1), (VII-2), and (VII-3) under the item [Chem. 5] and the compounds represented by the formulas (VII-1-1), (VII-1-2), and (VII-3) under the item [Chem. 6]. The azobenzene structure may be contained in the main chain or a side chain of the polymer constituting the alignment film 23. The “azobenzene structure” as used herein refers to any of azobenzene having a structure including two benzene rings linked by an azo group (—N═N—) and derivatives thereof. One example of the trans-azobenzene structures thereof is represented by the following formula (1) and one example of the cis-azobenzene structures thereof is represented by the following formula (2).

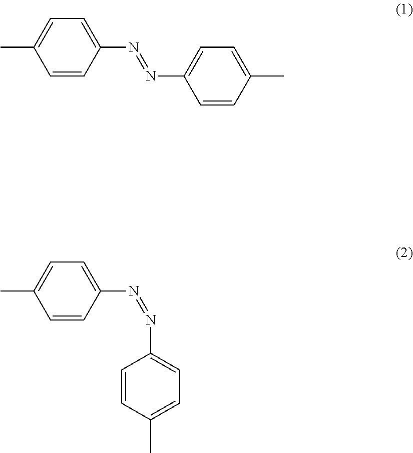

An azobenzene structure is a photo-functional group that controls the alignment of molecules in the desired direction by repeatedly undergoing the trans-cis reaction by polarized ultraviolet light irradiation in the photo-alignment treatment and allowing the trans-azobenzene structures aligned in the direction perpendicular to the polarized light irradiation direction to be dominant. Meanwhile, cis-azobenzene structures remain in the alignment film 23 even after the photo-alignment treatment. These cis-azobenzene structures, when irradiated with visible light polarized in the same direction as their absorption axis direction, are isomerized to the trans-azobenzene structures as shown in the following reaction scheme (3). The trans-azobenzene generated in the reaction here unfortunately controls the alignment of molecules in a direction different from the desired alignment direction provided by the photo-alignment treatment to disturb the alignment control by the alignment film 23, deteriorating the contrast characteristics.

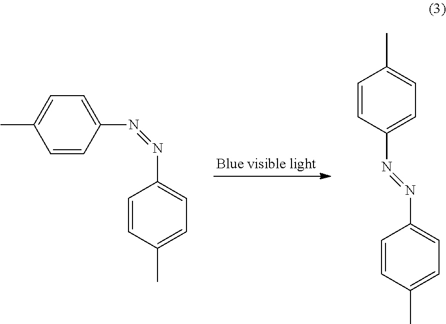 [SMILES: Cc1ccc(/N=N\c2ccc(C)cc2)cc1 ; Cc1ccc(/N=N/c2ccc(C)cc2)cc1]

In contrast, in the liquid crystal display device of the present embodiment, as illustrated in FIG. 1, the linear polarizer 21 has a polarized light transmission axis (i.e., a polarization direction 21A for the backlight illumination) that intersects a direction in which the alignment film 23 has larger absorption anisotropy (i.e., an absorption axis direction 23A of the cis-azobenzene). This configuration prevents cis-azobenzene from absorbing light and thus from being isomerized. Thereby, the liquid crystal display device can prevent a decrease in the alignment control by the alignment film 23. The angle formed by the polarized light transmission axis of the linear polarizer 21 and the direction in which the alignment film 23 has larger absorption anisotropy is preferably 45° or greater, more preferably 60° or greater, still more preferably substantially a right angle, particularly preferably a right angle. The direction in which the alignment film 23 has larger absorption anisotropy can be determined based on absorption of visible light (with a wavelength of 380 nm to shorter than 800 nm). Alternatively, since azobenzene has an absorption peak at a wavelength around 440 nm in the absorption spectrum, the direction can also be determined based on absorption of light with a wavelength of 400 to 500 nm (blue visible light).

One or both of the first substrate 22 and the second substrate 42 is/are provided with electrodes for application of voltage to the liquid crystal layer 30. Upon application of voltage by the electrodes to the liquid crystal layer 30, the alignment of the liquid crystal molecules 31 is changed according to the size of the applied voltage. Thereby, the polarization of the polarized light passing through the liquid crystal layer 30 can be controlled. The above electrodes are usually in a layer used as an undercoat layer of the alignment film 23. The material of the electrodes may be, for example, a transparent conductive material such as indium tin oxide (ITO) or indium zinc oxide (IZO).

A linear polarizer (polarizing plate) 43 is disposed on the viewing side of the second substrate 42. The light having passed through the second substrate 42 is incident on the linear polarizer 43 which transmits only linearly polarized light that oscillates along the polarized light transmission axis of the linear polarizer 43. The polarized light transmission axis direction of the linear polarizer 43 preferably intersects the polarized light transmission axis direction of the linear polarizer 21 at any angle, more preferably at substantially a right angle, particularly preferably at a right angle. The linear polarizer 43 can be the same polarizer as the linear polarizer 21. An optical film such as a retardation film may be disposed between the linear polarizer 43 and the second substrate 42.

The liquid crystal display device of the present embodiment has a configuration including components such as a liquid crystal display panel; external circuits such as a tape-carrier package (TCP) and a printed circuit board (PCB); optical films such as a viewing angle-increasing film and a luminance-increasing film; a backlight unit; and a bezel (frame). Some components, if appropriate, may be incorporated into another component. In addition to the components described above, the liquid crystal display device may include any components that are usually used in the field of liquid crystal display devices. The additional components are therefore not described here.

Each and every detail described for the above embodiment of the present invention shall be applied to all the aspects of the present invention.

The present invention is described below in more detail based on examples. The examples, however, are not intended to limit the scope of the present invention.

### Example 1

A liquid crystal display device having the configuration of Embodiment 1 was produced by the following method.

A TFT substrate including components such as TFTs and FFS electrode structures on a 0.7-mm-thick glass substrate was prepared as the first substrate 22. Each TFT included a channel formed by an oxide semiconductor, indium gallium zinc oxide (IGZO). Each FFS electrode structure had an electrode width L of 3 μm and an electrode space S of 5 μm. The pixel electrode constituting each FFS electrode structure was a transparent electrode made of ITO. Each pixel electrode had a thickness of 300 nm. Also, a CF substrate including a black matrix, color filters, and photo-spacers was prepared as the second substrate 42. Each photo-spacer had a height of 3.5 μm.

An alignment film solution was applied to the surface of each of the first substrate 22 and the second substrate 42. The solids content of the alignment film solution was a material containing polyamic acid, with a structural unit represented by the following formula (4). The solvent of the alignment film solution was an equal mixture of N-methyl-2-pyrrolidone and ethylene glycol monobutyl ether. The solids concentration of the alignment film solution was 4 wt %.

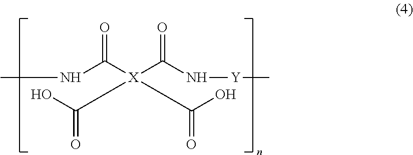

In the above formula (4), X represents a hydrocarbon group; Y represents a structural unit represented by the following formula (5) which contains an azobenzene structure (photo-functional group) in the main chain; and n is any number.

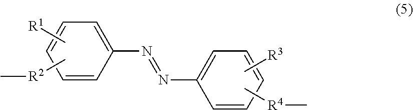

In the above formula (5), groups with unspecified binding positions each represent a group binding to any position of the benzene ring. The modifying groups R¹ and R³ and the spacer groups R² and R⁴ are independent of each other, and may not be present. The modifying groups R¹ and R³ each represent a monovalent organic group, and may not be present. The spacer groups R² and R⁴ each represent a single bond or a monovalent organic group.

After the application of the alignment film solution, the substrates 22 and 42 were temporarily dried at 70° C. for 2 minutes. Subsequently, the photo-alignment treatment was performed by irradiating the temporarily dried surface of each of the substrates 22 and 42 from the substrate normal direction with linearly polarized ultraviolet light having a wavelength of 365 nm with an irradiation intensity of 1 J/cm². The degree of polarization of the radiated polarized ultraviolet light was 7:1 at a wavelength of 365 nm.

The post-baking was performed by heating the substrates 22 and 42 at 120° C. for 20 minutes, and then at 200° C. for 30 minutes. The post-baking causes imidization of the solids content (cyclodehydration of amic acid structures) to generate a polyimide represented by the following formula (6). For efficient thermal self-organization through the post-baking after the photo-alignment treatment, the solids content preferably remains as a polyamic acid represented by the above formula (4) in the photo-alignment treatment. Each post-baked alignment film had a thickness of about 100 nm. Thereby, the alignment films 23 and 41 were formed.

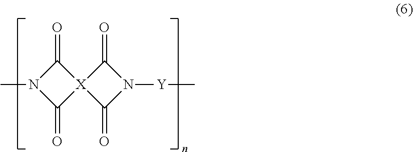

In the above formula (6), X, Y, and n are the same as those in the above formula (4).

On the first substrate 22, a heat/visible light-curable sealant (Kyoritsu Chemical & Co., Ltd., trade name: World Rock) was poured with a dispenser. The first substrate 22 and the second substrate 42 were then attached to each other with a liquid crystal material in between while the polarization directions of ultraviolet light radiated in the photo-alignment treatment were adjusted to be parallel to each other, whereby a cell was produced. The liquid crystal material used had negative anisotropy of dielectric constant and a scattering parameter (SP) of 9.0×10⁹ N⁻¹. During attachment of the substrates 22 and 42, the sealant was exposed to light for curing, with the display region shielded from light.

The scattering parameter is a value defined by the following formula (JP 4990402 B).

SP=(Δn×(ne+no)²×Δn)/K

In the formula, Δn represents refractive index anisotropy of the liquid crystal material, ne represents an extraordinary light refractive index of the liquid crystal material, no represents an ordinary light refractive index of the liquid crystal material, K represents the average value of the splay, twist, and bend elastic constants K₁₁, K₂₂, and K₃₃.

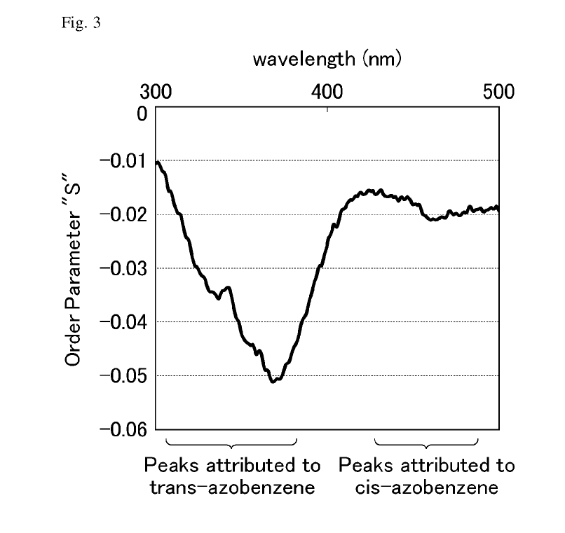

The cell was then heated at 130° C. for 40 minutes, so that the liquid crystal molecules 31 were re-aligned. Thereby, a FFS-mode liquid crystal display panel in which the liquid crystal molecules were uniformly uniaxially aligned was produced. FIG. 2 is a view for describing the relation between an alignment film and liquid crystal molecules in a horizontal alignment mode. As illustrated in FIG. 2, the polymer constituting each of the alignment films 23 and 41 has a structure with photo-functional portions P2 in its main chain P1, and the liquid crystal molecules 31 are aligned in parallel with the polymer constituting each of the alignment films 23 and 41.

The polarizing plates 21 and 43 were attached respectively to the back surface side (backlight illumination incident side) of the first substrate 22 and the viewing side (backlight illumination emission side) of the second substrate 42 of the obtained FFS-mode liquid crystal panel such that the axes were arranged as illustrated in FIG. 1. The degree of polarization of each of the polarizing plates 21 and 43 in the present example was 12000:1. Both the direction in which the alignment film 23 has larger absorption anisotropy and an alignment direction 31A of the liquid crystal molecules correspond to the direction perpendicular to the polarization direction of ultraviolet light in the photo-alignment treatment. Thereby, a liquid crystal panel with polarizing plates was produced.

The alignment films 23 and 41 in the liquid crystal panel with polarizing plates in the present example exhibit anisotropic absorption of visible light. The results of determining the absorption anisotropy of each of the alignment films 23 and 41 are shown in FIG. 3.

FIG. 3 is a graph showing the order parameter of a post-baked photo-alignment film used in Example 1. The order parameter S is a value defined by the formula S=(A//−A⊥)/(A//+2A⊥). Here, A// represents the absorbance during the photo-alignment treatment in the direction parallel to the polarization direction of ultraviolet light, and A⊥ represents the absorbance during the photo-alignment treatment in the direction perpendicular to the polarization direction of ultraviolet light. As is clear from the above definition, a negative order parameter S means that the absorbance is larger in the direction perpendicular to the polarization direction than in the direction parallel to the polarization direction.

FIG. 3 shows that at wavelengths around 300 to 400 nm and wavelengths around 400 to 500 nm, the direction in which the alignment film 23 has larger absorption anisotropy is perpendicular to the polarization direction of ultraviolet light during the photo-alignment treatment. Azobenzene is generally known to undergo trans-to-cis isomerization when irradiated with near-ultraviolet light (wavelength: around 320 nm) and undergo cis-to-trans isomerization when irradiated with visible light (wavelength: around 440 nm). This suggests that the peaks at wavelengths around 300 to 400 nm in FIG. 3 are attributed to trans-azobenzene, and the peaks at wavelengths around 400 to 500 nm are attributed to cis-azobenzene.

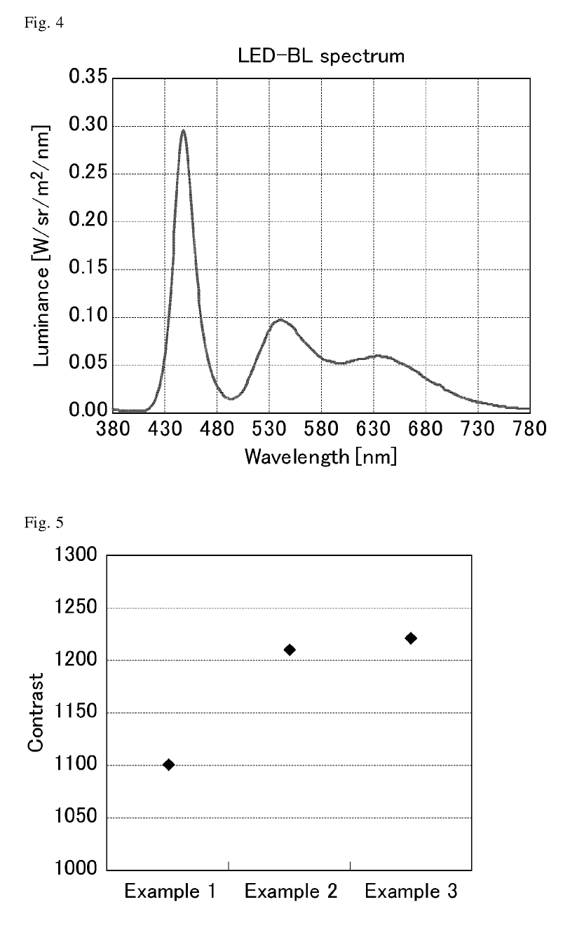

FIG. 4 is a graph showing the luminescence spectrum of a white LED backlight. As shown in FIG. 4, the backlight illumination includes blue visible light with a wavelength around 400 to 500 nm. This means that when the polarizing plate 21 and the panel are disposed such that the absorption axis direction 23A of cis-azobenzene in the alignment film 23 and the polarization direction of light incident through the polarizing plate 21 from the backlight 10 are the same, cis-azobenzene absorbs backlight illumination during use of the liquid crystal display device. Cis-azobenzene, upon absorption of light, isomerizes to trans-azobenzene which unfortunately has alignment force in a direction different from the originally intended direction. Such alignment force causes an increase in the light leakage from the panel during black display, and thus decreases the contrast of the liquid crystal display device.

In contrast, the present example employs a configuration in which the absorption axis direction 23A of cis-azobenzene in the alignment film 23 is perpendicular to the polarization direction of light incident from the backlight 10 side. This configuration prevents light absorption by cis-azobenzene, giving a liquid crystal panel that achieves favorable contrast characteristics for a long period of time.

Azobenzene constituting the alignment film 23 provides horizontal alignment to the liquid crystal molecules 31 in the direction perpendicular to the polarization direction of light radiated in the photo-alignment treatment. That is, the absorption axis direction 23A provided to the alignment film 23 in the photo-alignment treatment (i.e., direction in which absorption anisotropy is larger) and the alignment direction 31A of the liquid crystal molecules 31 in the liquid crystal layer 30 with voltage equal to or lower than the threshold voltage applied are parallel to each other. Accordingly, since the present example employs a configuration in which light incident on the liquid crystal panel during use is designed to be perpendicular not only to the absorption axis direction 23A of cis-azobenzene in the alignment film 23 but also to the major axis direction of each liquid crystal molecule 31, the liquid crystal display device can also achieve the effect of preventing photo-degradation of the liquid crystal material over long-term use.

For confirmation of the above effects, the liquid crystal panel with polarizing plates produced in Example 1, undriven, was subjected to a 1000-hour exposure test using a white LED backlight having the luminescence spectrum shown in FIG. 4 and a luminance of 10,000 cd/m².

Microscopic observation of the liquid crystal panel of Example 1 before and after the exposure test found no change.

The results of measuring the light leakage amount in black display (with no voltage applied to the liquid crystal layer) using a photomultiplier tube before and after the exposure test were also the same.

These confirmation results show that in Example 1, the reaction of cis-azobenzene was prevented during the exposure test and the alignment control was maintained at a high level.

Also, the voltage holding ratio (VHR) was measured before and after the exposure test. As a result, the liquid crystal panel of Example 1 showed a VHR before the test of 99.2% and a VHR after the test of 98.0%. These results show that the VHR change before and after the exposure test was small, and the VHR reliability was therefore favorable. These favorable results were owing to the alignment film 23 used in Example 1 which aligned the liquid crystal molecules 31 in the direction perpendicular to the polarization direction of ultraviolet light during the photo-alignment treatment (i.e., in the direction parallel to the absorption axis direction 23A of cis-azobenzene in the alignment film 23), leading to incidence of light polarized through the linear polarizer 21 in the exposure test in the direction orthogonal to the major axis direction of each liquid crystal molecule 31. Also, prevention of light absorption by cis-azobenzene in the alignment film 23 probably enabled prevention of an ionization reaction and a decomposition reaction as well as the isomerization reaction generating trans-azobenzene. This effect would have also contributed to prevention of a decrease in VHR.

### Comparative Example 1

FIG. 11 is an exploded perspective view schematically illustrating the configuration of a liquid crystal display device of Comparative Example 1. The liquid crystal panel of Comparative Example 1 was produced by the same procedure as that in Example 1, and includes in the following order from the back surface side, a backlight 110 that emits light including visible light; a linear polarizer 121; a first substrate 122; an alignment film 123; a liquid crystal layer 130; an alignment film 141; and a second substrate 142. The polarizing plates 121 and 143 were attached respectively to the back surface side (backlight illumination incident side) of the first substrate 122 and the viewing side (backlight illumination emission side) of the second substrate 142 of the obtained FFS-mode liquid crystal panel such that the axes were arranged as illustrated in FIG. 11. The polarizing plates 121 and 143 in Comparative Example 1 are in an arrangement obtained by rotating the arrangement in Example 1 by 90° relative to the FFS-mode liquid crystal panel.

Since the absorption axis direction of cis-azobenzene in the alignment film 123 in the configuration of Comparative Example 1 is the same as the polarization direction of light incident from the backlight 110 side, cis-azobenzene which absorbs light having a wavelength of 400 to 500 nm undergoes a reaction during use of the liquid crystal display device. This generates alignment force in a direction different from the direction provided by the alignment treatment, increasing the light leakage from the panel in black display.

For confirmation of the above results, the liquid crystal panel with polarizing plates produced in Comparative Example 1 was subjected to the backlight exposure test under the same conditions as those in Example 1.

Microscopic observation of the liquid crystal panel of Comparative Example 1 before and after the exposure test found the liquid crystal panel after the exposure test had pixel roughness which was not observed before the exposure test.

The results of measuring the light leakage amount in black display (with no voltage applied to the liquid crystal layer) using a photomultiplier tube before and after the exposure test showed a 5% increase in the light leakage amount.

As shown above, the panel of Comparative Example 1 was actually confirmed to exhibit deteriorated alignment characteristics under light exposure compared to Example 1.

This is probably because blue visible light included in the backlight illumination from the LED backlight in Comparative Example 1 causes reaction of cis-azobenzene in the alignment film during exposure, inhibiting the alignment control.

Also, the voltage holding ratio (VHR) was measured before and after the exposure test. As a result, the liquid crystal panel of Comparative Example 1 showed a VHR before the test of 99.3% and a VHR after the test of 97.1%. These results show that the voltage holding ratio decreased under light exposure compared to that in Example 1. This result was due to the alignment film 123 used in Comparative Example 1 which aligned the liquid crystal molecules 131 in the direction perpendicular to the polarization direction of ultraviolet light during the photo-alignment treatment (i.e., in the direction parallel to the absorption axis direction of cis-azobenzene in the alignment film 123), leading to incidence of light polarized through the linear polarizer 121 in the exposure test in the direction parallel to the major axis direction of each liquid crystal molecule 131.

### Example 2

A liquid crystal panel with polarizing plates was produced by the same procedure as that in Example 1 except that the polarized ultraviolet light radiated in the photo-alignment treatment had a degree of polarization of 30:1 at a wavelength of 365 nm.

FIG. 5 is a graph showing initial contrast measurement results of liquid crystal panels of Examples 1 to 3. As shown in FIG. 5, the liquid crystal panel of Example 2 was evaluated to have a higher initial contrast than the liquid crystal panel of Example 1 by 10%. That is, the panel of Example 2, which employed a higher degree of polarization of ultraviolet light radiated in the photo-alignment treatment, was able to achieve better contrast performance than that of Example 1. These results show that alignment treatment is preferably performed with light having a degree of polarization of 30:1 or higher to maximize the alignment performance of the photo-alignment film. The initial contrast performance was enhanced because the order parameter S was set high. A high order parameter S of the initial alignment leads to large absorption anisotropy, which makes the alignment film more susceptible to the polarization direction of the incident light, more significantly contributing to the effect of the present invention of enhancing the alignment characteristics under light exposure.

As in Example 1, the exposure test was performed. The results of measuring the light leakage amount in black display (with no voltage applied to the liquid crystal layer) using a photomultiplier tube before and after the exposure test were the same. These results show that the panel achieved excellent light resistance.

### Example 3

A liquid crystal panel with polarizing plates was produced by the same procedure as that in Example 1 except that the ultraviolet light radiated in the photo-alignment treatment had a degree of polarization of 100:1 at a wavelength of 365 nm.

As shown in FIG. 5, the liquid crystal panel of Example 3 was evaluated to have a higher initial contrast than the liquid crystal panel of Example 1 by 11%. That is, the panel of Example 3, which employed a higher degree of polarization of ultraviolet light radiated in the photo-alignment treatment, also led to better contrast performance as in Example 2. However, the improvement from Example 2 to Example 3 was smaller than the improvement from Example 1 to Example 2. This result shows that with a degree of polarization of 30:1 or higher, the contrast performance of the liquid crystal panel substantially reached a plateau. Hence, the suitable range of the degree of polarization is 30:1 or higher.

As in Example 1, the exposure test was performed. The results of measuring the light leakage amount in black display (with no voltage applied to the liquid crystal layer) using a photomultiplier tube before and after the exposure test were the same. These results show that the panel achieved excellent alignment characteristics under light exposure.

### Examples 4 and 5

A liquid crystal panel with polarizing plates of Example 4 was produced by the same procedure as that in Example 1 except that the liquid crystal material had negative anisotropy of dielectric constant and a scattering parameter of 5.0×10⁹ N⁻¹. A liquid crystal panel with polarizing plates of Example 5 was produced by the same procedure as that in Example 1 except that the liquid crystal material had negative anisotropy of dielectric constant and a scattering parameter of 7.0×10⁹ N⁻¹.

The initial contrasts of the liquid crystal panel of Example 1 and the liquid crystal panels of Examples 4 and 5 were evaluated. As a result, the liquid crystal panel of Example 4 showed a smaller light leakage amount in black display (with no voltage applied to the liquid crystal layer) than that of Example 1 by 8%. Also, the liquid crystal panel of Example 5 showed a smaller light leakage amount in black display than that of Example 1 by 3%. These results show that use of a liquid crystal material with a lower scattering parameter enables prevention of light scattering in the liquid crystal layer 30, thereby achieving even better contrast performance.

### Examples 6 and 7

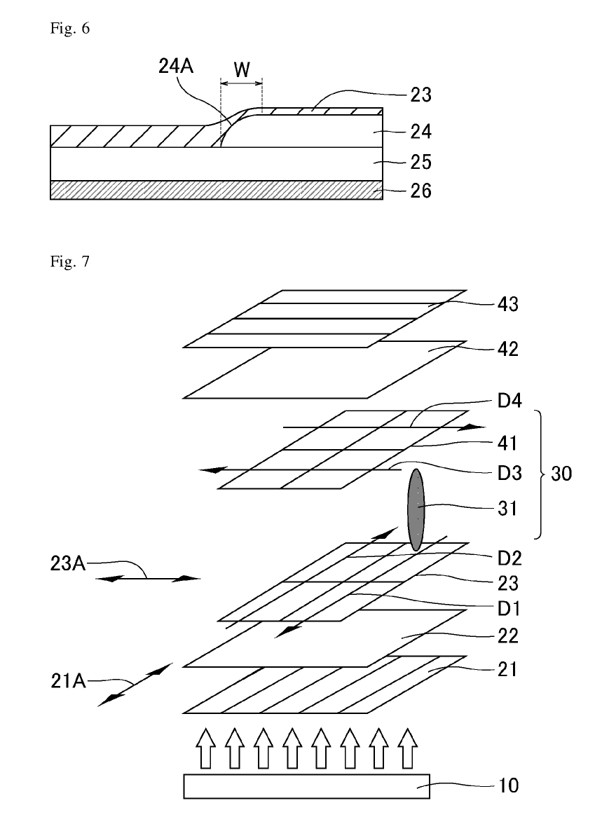

A liquid crystal panel with polarizing plates of Example 6 was produced by the same procedure as that in Example 1 except that the thickness of the pixel electrodes constituting the FFS electrode structure was 150 nm. A liquid crystal panel with polarizing plates of Example 7 was produced by the same procedure as that in Example 1 except that the thickness of the pixel electrodes constituting the FFS electrode structure was 80 nm. FIG. 6 is a schematic cross-sectional view of the configuration in the vicinity of a pixel electrode on a TFT substrate used in Examples 6 and 7. FIG. 6 illustrates paired electrodes in the FFS electrode structure, namely a pixel electrode 24 and a planar common electrode 26, an insulating film 25 that electrically insulates the pixel electrode 24 and the common electrode 26, and an alignment film 23 formed on the pixel electrode 24.

An increase in the thickness of the pixel electrode 24 may cause light leakage due to the following reasons.

As illustrated in FIG. 6, the pixel electrode 24 has a gradient (slope) 24A at its end. When an alignment film solution is applied to the substrate with this gradient 24A, the solution on the gradient 24A runs down onto the insulating film 25 before completion of the temporal drying treatment. Here, as the thickness of the pixel electrode 24 increases, the width W of the gradient 24A increases, which leads to an increase in the amount of the solution running down onto the insulating film 25. Portions with such an increase may be observed as portions with light leakage. Hence, the panel of Example 1 had portions with slight light leakage along the pixel electrodes 24 which are parts for transmitting light.

In contrast, a configuration in which the pixel electrodes 24 are designed to have a thickness of a certain value or smaller can sufficiently prevent light leakage at the ends of the pixel electrodes 24, achieving higher contrast performance. Microscopic observation of the liquid crystal panels of Examples 6 and 7 found no light leakage along the pixel electrodes 24 which are parts for transmitting light. These results of Examples 6 and 7 show that the thickness of the pixel electrodes 24 is preferably 150 nm or smaller.

In the IPS mode, the alignment film 23 is disposed to cover the common electrode as well as the pixel electrodes 24. Hence, in the case of the IPS mode, both the pixel electrodes 24 and the common electrode preferably have a thickness of 150 nm or smaller.

### Example 8

The present invention can be applied to a vertical alignment mode as well as the horizontal alignment mode such as the IPS mode and the FFS mode. Example 8 is an example in which the present invention is applied to a vertical alignment twisted nematic (VAIN) mode which is a kind of vertical alignment mode.

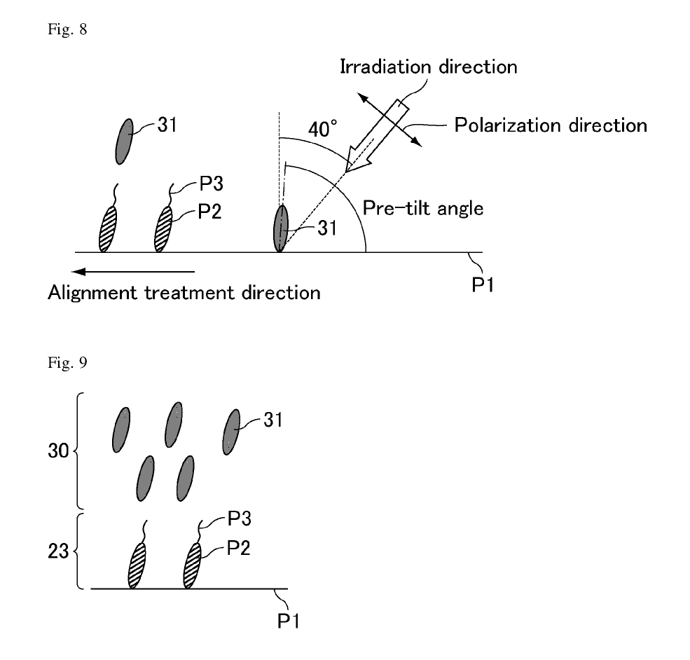

FIG. 7 is an exploded perspective view schematically illustrating the configuration of a liquid crystal display device of Example 8. FIG. 8 is a view for describing photo-alignment treatment in Example 8.

A liquid crystal display device having the configuration of Example 8 was produced by the following method.

A TFT substrate including components such as TFTs and pixel electrodes on a 0.7-mm-thick glass substrate was prepared as the first substrate 22. Each TFT included channels formed by an oxide semiconductor, indium gallium zinc oxide (IGZO). Each pixel electrode was a transparent electrode made of ITO. Each pixel electrode had a thickness of 150 nm. Also, a CF substrate including a black matrix, color filters, photo-spacers, and a transparent electrode made of ITO was prepared as the second substrate 42. Each photo-spacer had a height of 3.5 μm.

An alignment film solution was applied to the surface of each of the first substrate 22 and the second substrate 42. The solids content of the alignment film solution was a material containing polyamic acid that has a different diamine structure from the material of Example 1, i.e., with the azobenzene structure as a photo-functional group in a side chain, and provides vertical alignment. The solvent of the alignment film solution was an equal mixture of N-methyl-2-pyrrolidone and ethylene glycol monobutyl ether. The solids concentration of the alignment film solution was 4 wt %.

After the application of the alignment film solution, the substrates 22 and 42 were temporarily dried at 70° C. for 2 minutes. The post-baking was then performed by heating the substrates 22 and 42 at 230° C. for 30 minutes. Each post-baked alignment film had a thickness of about 100 nm.

As illustrated in FIG. 8, the photo-alignment treatment was performed by irradiating the surface of each of the substrates 22 and 42 from an oblique direction inclined at an angle of 40° from the substrate normal direction with linearly P-polarized ultraviolet light (white arrows in FIG. 8) having a wavelength of 365 nm with an irradiation intensity of 1 J/cm². The degree of polarization of the radiated polarized ultraviolet light was 7:1 at a wavelength of 365 nm. Here, the photo-alignment treatment was performed in four directions, namely the directions D1 and D2 for the alignment film 23 and the directions D3 and D4 for the alignment film 41, so that four domains were formed per pixel.

The steps such as pouring of the sealant, sealing of the liquid crystal material, attachment of the substrates 22 and 42, and re-alignment treatment were performed by the same procedure as that in Example 1, whereby a liquid crystal panel was produced. The substrates 22 and 42 were attached to each other with the photo-alignment treatment directions D1 and D2 for the substrate 22 and the photo-alignment treatment directions D3 and D4 for the substrate 42 being perpendicular to each other as illustrated in FIG. 7. The liquid crystal material used was negative liquid crystal having negative anisotropy of dielectric constant.

The polarizing plates 21 and 43 were attached respectively to the back surface side (backlight illumination incident side) of the first substrate 22 and the viewing side (backlight illumination emission side) of the second substrate 42 of the obtained liquid crystal panel such that the axes were arranged as illustrated in FIG. 7. The degree of polarization of each of the polarizing plates 21 and 43 in the present example was 12000:1. Thereby, a liquid crystal panel with polarizing plates was produced.

The liquid crystal panel with polarizing plates in the present example is in a display mode of VATN mode. In the VATN mode, when AC voltage equal to or higher than the threshold voltage is applied between the substrates 22 and 42, the liquid crystal molecules 31 are twisted 90° in the substrate surface normal direction between the substrates 22 and 42. Also, the average liquid crystal director direction with AC voltage applied halves the angle formed by the respective photo-irradiation directions for the substrates 22 and 42 in a plan view of the substrates 22 and 42. That is, four domains can be formed in which the alignment directions of the liquid crystal molecules 31 present near the center of the liquid crystal layer 30 in the thickness direction are perpendicular to each other. As described above, one pixel is divided to four domains in the VAIN mode, so that a wide viewing angle can be achieved.

The alignment films 23 and 41 in the liquid crystal display panel with polarizing plates in the present example exhibit anisotropic absorption of visible light. In the present example, the direction in which the alignment film 23 has larger absorption anisotropy corresponds to the direction perpendicular to the polarization direction of ultraviolet light during the photo-alignment treatment. The absorption axis direction 23A of cis-azobenzene in the alignment film 23 and the polarization direction of light incident from the backlight side are therefore perpendicular to each other. This configuration prevents light absorption by cis-azobenzene, giving a liquid crystal panel that achieves favorable contrast characteristics for a long period of time.

For confirmation of the above effects, the liquid crystal panel with polarizing plates produced in Example 8, undriven, was subjected to a 1000-hour exposure test using a white LED backlight having the luminescence spectrum shown in FIG. 4 and a luminance of 10,000 cd/m².

Microscopic observation of the liquid crystal panel of Example 8 before and after the exposure test found no change.

The results of measuring the light leakage amount in black display (with no voltage applied to the liquid crystal layer) using a photomultiplier tube before and after the exposure test were also the same.

These confirmation results show that in Example 8, the reaction of cis-azobenzene was prevented during the exposure test and the alignment control was maintained at a high level.

Also, the voltage holding ratio (VHR) was measured before and after the exposure test. As a result, the liquid crystal panel of Example 8 showed a VHR before the test of 99.0% and a VHR after the test of 98.1%. These results show that the VHR change before and after the exposure test was small, and the VHR reliability was therefore favorable. These favorable results were owing to the alignment film 23 used in Example 8 which vertically aligned the liquid crystal molecules 31, leading to incidence of light polarized through the linear polarizer 21 in the exposure test in the direction orthogonal to the major axis direction of each liquid crystal molecule 31.

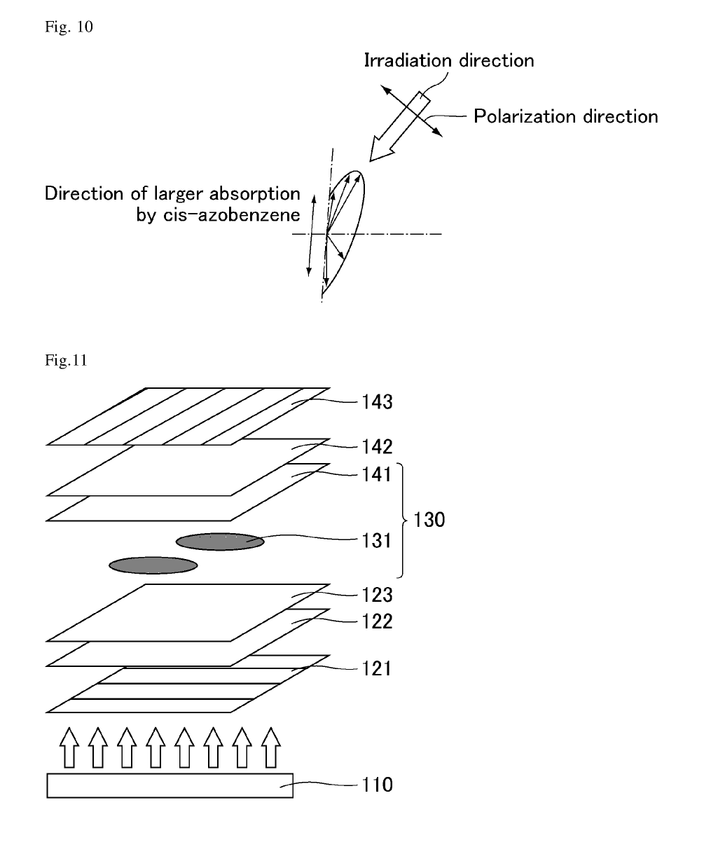

The following gives supplementary description of the difference between the vertical alignment mode in the present example and the horizontal alignment mode in Examples 1 to 5 with reference to FIG. 9 and FIG. 10.

FIG. 9 is a view for describing the relation between photo-functional groups and liquid crystal molecules in a vertical alignment mode. FIG. 10 is a view for describing the relation between the polarization provided by photo-alignment treatment and the direction of the absorption axis of a cis-azobenzene structure in a vertical alignment mode.

As shown in FIG. 9, differently from a horizontal alignment mode, a polymer constituting the alignment film 23 in a vertical alignment mode contains photo-functional portions P2 and liquid crystal alignment portions P3 in side chains. Here, the liquid crystal alignment portions P3 each typically have a structure (mesogenic group) similar to the liquid crystal molecule backbone. The direction with larger absorption anisotropy of cis-azobenzene (absorption axis direction 23A of cis-azobenzene) generated by polarized light irradiation is perpendicular to the polarized light as in the case of a horizontal alignment mode. Still, since the photo-functional portions P2 and the liquid crystal alignment portions P3 are rising from the substrate surface, the degree of the absorption anisotropy is lower than that in the case of a horizontal alignment mode. Hence, blue visible light incident through the polarizing plate 21 from the backlight 10 side is considered to have a smaller influence on the isomerization reaction. For these reasons, the effects of the present invention can be achieved at the maximum in a horizontal alignment mode.

### [Additional Remarks]

The above embodiment and examples lead to the following modes of the present invention. The modes may appropriately be combined with each other within the spirit of the present invention.

One mode of the present invention may be a liquid crystal display device including, in the following order from a back surface side: the backlight 10 that emits light including visible light; the linear polarizer 21; the first substrate 22; the alignment film 23; the liquid crystal layer 30 that contains the liquid crystal molecules 31; and the second substrate 42. The alignment film 23 may contain a material with an azobenzene structure that exhibits anisotropic absorption of visible light and isomerizes upon absorption of visible light. The linear polarizer may have a polarized light transmission axis that intersects a direction in which the alignment film 23 has larger absorption anisotropy.

The liquid crystal display device of the above mode can prevent cis-azobenzene contained in the alignment film 23 after the photo-alignment treatment from absorbing backlight illumination. The liquid crystal display device therefore can prevent isomerization reaction generating trans-azobenzene that aligns the molecules in a direction different from the alignment direction provided by the photo-alignment treatment. Thereby, the liquid crystal display device can maintain favorable alignment control using the alignment film 23 even when the backlight is turned on for a long period of time. Accordingly, the present invention can provide a liquid crystal display device that prevents an increase in light leakage in black display and has favorable contrast characteristics for a long period of time.

In the above mode, the alignment film 23 may give a pre-tilt angle of substantially 0° to the liquid crystal molecules 31. This configuration increases the effect of preventing absorption by cis-azobenzene.

In the above mode, the liquid crystal display device may be in a display mode of an IPS mode or FFS mode. This configuration increases the effect of preventing absorption by cis-azobenzene.

In the above mode, the liquid crystal molecules 31 may have negative anisotropy of dielectric constant. This configuration increases the effect of preventing absorption by cis-azobenzene.

In the above mode, the direction in which the alignment film 23 has larger absorption anisotropy may be parallel to the alignment direction 31A of liquid crystal molecules in the liquid crystal layer 30 with voltage equal to or lower than the threshold voltage applied. With this configuration, since the light incident on the liquid crystal panel from the backlight 10 intersects the major axis direction of each liquid crystal molecule 31, the liquid crystal display device can prevent photo-degradation of the liquid crystal material over long-term use.

In the above mode, the liquid crystal layer may contain a liquid crystal material having a scattering parameter of 9.0×10⁹ N⁻¹ or lower. Use of a liquid crystal material with a lower scattering parameter enables prevention of light scattering in the liquid crystal layer 30, thereby achieving even better contrast performance.

In the above mode, the first substrate 22 may include the pixel electrode 24 that has a thickness of 150 nm or smaller and is covered with the alignment film 23. A configuration in which the pixel electrodes 24 are designed to have a thickness of 150 nm or smaller can sufficiently prevent light leakage at the ends of the pixel electrodes 24, achieving higher contrast performance.

Another mode of the present invention may be a method for producing the liquid crystal display device described above, including an alignment treatment for the alignment film 23 using linearly polarized ultraviolet light with a degree of polarization of 30:1 or higher. The method for producing a liquid crystal display device according to the above mode includes photo-alignment treatment with light having a high degree of polarization, maximizing the alignment performance of the alignment film 23. As a result, the initial contrast performance can be enhanced. When the initial contrast performance is enhanced, the method can significantly achieve the effects of the present invention which are obtained by appropriately setting the polarized light transmission axis of the linear polarizer 21 and the direction in which the alignment film 23 has larger absorption anisotropy.

### REFERENCE SIGNS LIST

10: backlight
21: linear polarizer (polarizing plate)
21A: polarization direction of backlight illumination
22: first substrate
23: alignment film
23A: absorption axis direction of cis-azobenzene
24: pixel electrode
24A: gradient portion
25: insulating film
26: common electrode
30: liquid crystal layer
31: liquid crystal molecule
31A: alignment direction of liquid crystal molecule
41: alignment film
42: second substrate
43: linear polarizer (polarizing plate)
D1 to D4: photo-alignment treatment direction
P1: main chain of polymer
P2: photo-functional portion of polymer
P3: liquid crystal alignment portion of polymer
W: width of gradient portion

1. A liquid crystal display device comprising, in the following order from a back surface side:
a backlight that emits light including visible light;
a linear polarizer;
a first substrate;
an alignment film;
a liquid crystal layer that contains liquid crystal molecules; and
a second substrate,
the alignment film containing a material with an azobenzene structure that exhibits anisotropic absorption of visible light and isomerizes upon absorption of visible light,
the linear polarizer having a polarized light transmission axis that intersects a direction in which the alignment film has larger absorption anisotropy.

2. The liquid crystal display device according to claim 1,
wherein the alignment film gives a pre-tilt angle of substantially 0° to the liquid crystal molecules.

3. The liquid crystal display device according to claim 1,
which is in a display mode of an IPS mode or FFS mode.

4. The liquid crystal display device according to claim 1,
wherein the liquid crystal molecules have negative anisotropy of dielectric constant.

5. The liquid crystal display device according to claim 1,
wherein the direction in which the alignment film has larger absorption anisotropy is parallel to the alignment direction of the liquid crystal molecules in the liquid crystal layer with voltage equal to or lower than the threshold voltage applied.

6. The liquid crystal display device according to claim 1,
wherein the liquid crystal layer contains a liquid crystal material having a scattering parameter of 9.0×10⁹ N⁻¹ or lower.

7. The liquid crystal display device according to claim 1,
wherein the first substrate includes a pixel electrode that has a thickness of 150 nm or smaller and is covered with the alignment film.

8. A method for producing the liquid crystal display device according to claim 1, comprising
an alignment treatment for the alignment film using linearly polarized ultraviolet light with a degree of polarization of 30:1 or higher.
